(19) United States
(12) Patent Application Publication
(10) Pub. No.: US 2025/0209954 A1
(43) Pub. Date: Jun. 26, 2025

(54) Low Memory Pixel Uniformity Compensation for Display Defects

(71) Applicant: Apple Inc., Cupertino, CA (US)

(72) Inventors: Chang-Jiang Chen, Cupertino, CA (US); Suraj P. Gorkhali, San Jose, CA (US); Patrick R. Cruce, Campbell, CA (US); Nicolas Le Dortz, Palo Alto, CA (US); Yanming Li, San Jose, CA (US); Hyunwoo Nho, Palo Alto, CA (US); Fangwang Gou, San Jose, CA (US); Hao Yang, Santa Clara, CA (US); Heesang Suh, Saratoga, CA (US); Jun Qi, San Jose, CA (US); Mookyung Son, Cupertino, CA (US)

(21) Appl. No.: 18/933,773

(22) Filed: Oct. 31, 2024

Related U.S. Application Data
(60) Provisional application No. 63/613,481, filed on Dec. 21, 2023.

(51) Int. Cl. G09G 3/20

(52) U.S. Cl. CPC G09G 3/2003; G09G 2320/0233; G09G 2320/0257; G09G 2320/0285

(57) ABSTRACT

An electronic display including a display panel that includes a plurality of display pixels having non-uniform luminance characteristics. The electronic display also includes pixel uniformity correction circuitry configured to compensate for the non-uniform luminance characteristics of the display pixels based on a pixel luminance correction factor selected based on pixel group luminance error patterns corresponding to locations of the display pixels.

### CROSS-REFERENCE TO RELATED APPLICATIONS

This application claims priority to U.S. Provisional Patent Application No. 63/613,481 entitled “Low Memory Pixel Uniformity Compensation for Display Defects,” filed on Dec. 21, 2023, which is hereby incorporated by reference in its entirety for all purposes.

### SUMMARY

A summary of certain embodiments disclosed herein is set forth below. It should be understood that these aspects are presented merely to provide the reader with a brief summary of these certain embodiments and that these aspects are not intended to limit the scope of this disclosure. Indeed, this disclosure may encompass a variety of aspects that may not be set forth below.

Electronic displays may be found in numerous electronic devices, from mobile phones to computers, televisions, automobile dashboards, and augmented reality or virtual reality glasses, to name just a few. Electronic displays with self-emissive display pixels, such as light-emitting diodes (LEDs), organic light-emitting diodes (OLEDs) or micro-light-emitting diodes (μLEDs), generate images by emitting different amounts of light. As different display pixels emit different amounts of light, individual display pixels of an electronic display may collectively produce images.

Due to various properties associated with manufacturing the display, a driving scheme of the pixels, and/or other characteristics, the display panel of the electronic display device may vary, having non-uniform luminance characteristics between pixel to pixel. These variations may be particularly noticeable when the pixels are operating at a low luminance. The range of variation between pixel to pixel may cause a coarse and/or rough front of screen (FOS) image artifact, which may be referred to as a high-frequency mura. Thus, the display panel may not appear to be entirely smooth and/or polished to a user. Therefore, images displayed on the display panel may lack clarity and/or may appear to include image artifacts.

At times, uniformity compensation may be implemented to improve visual quality of the electronic display. The uniformity compensation data may be calculated based on compensation generated from panel uniformity calibration. At times, the compensation may be proportional to a number of pixels and a bit-depth of each compensation component. However, one-to-one (e.g., 1×1) pixel compensation (e.g., per sub-pixel compensation) of the electronic display may involve a large amount of storage and thus may be costly in memory size. Further, the one-to-one pixel compensation may consume large amounts of power of the electronic display.

As such, pixel uniformity correction circuitry may compensate for the non-uniform luminance characteristics of the pixels in groups rather than one-to-one. In particular, the pixel uniformity correction circuitry may compensate for the non-uniform luminance characteristics by using one or more pixel luminance correction factors that are selected based on pixel group error patterns. The pixel group error patterns may correspond to locations of the pixels of the display. Moreover, the pixel group luminance error patterns may be associated with pixel groups of at least two-by-two (e.g., 2×2) pixels. A per-pixel-group set of correction factors may be applied to pixel data and sent to the pixels of the display to reduce or eliminate the non-uniform luminance characteristics within a threshold of human visual activity (e.g., process by which humans perceive and interpret visual information).

In an embodiment, the pixel uniformity correction circuitry may include a group index lookup table (LUT), a group pattern LUT, and/or a scaler LUT to provide compensation for the display pixels. Indeed, the group index LUT, the group pattern LUT, and/or the scaler LUT may enable determination of the pixel luminance correction factors. The group index LUT may define the pixel luminance correction factors based on the pixel group luminance error patterns. Moreover, the group pattern LUT may define locations of the pixel group luminance error patterns on the display panel. Further, the scaler LUT may define a scaling factor for the pixel luminance correction factors based on a global brightness setting of the electronic display. Thus, the group index LUT, the group pattern LUT, and/or the scaler LUT may compensate and control the voltage of each of the display pixels.

In another embodiment, the pixel uniformity correction circuitry may include a one-to-one LUT with a low bit depth (e.g., 1 to 3 bits per-pixel) and the scaler LUT. The pixel uniformity correction circuitry may compensate for the non-uniform luminance characteristics of the display pixels on the per-pixel basis based on a pixel correction factor applied to pixel data.

### BRIEF DESCRIPTION OF THE DRAWINGS

Various aspects of this disclosure may be better understood upon reading the following detailed description and upon reference to the drawings in which:

FIG. 1 is a block diagram of an electronic device that includes an electronic display, in accordance with an embodiment of the present disclosure;

FIG. 2 is an example of the electronic device of FIG. 1 in the form of a handheld device, in accordance with an embodiment of the present disclosure;

FIG. 3 is another example of the electronic device of FIG. 1 in the form of a tablet device, in accordance with an embodiment of the present disclosure;

FIG. 4 is another example of the electronic device of FIG. 1 in the form of a computer, in accordance with an embodiment of the present disclosure;

FIG. 5 is another example of the electronic device of FIG. 1 in the form of a watch, in accordance with an embodiment of the present disclosure;

FIG. 6 is another example of the electronic device of FIG. 1 in the form of a computer, in accordance with an embodiment of the present disclosure;

FIG. 7 is a block diagram of an electronic display of the electronic device, in accordance with an embodiment of the present disclosure;

FIG. 8 is an example illustration of image artifacts on the electronic display of the electronic device of FIG. 1, in accordance with an embodiment of the present disclosure;

FIG. 9 is a block diagram of pixel uniformity correction circuitry of the electronic device of FIG. 1, in accordance with an embodiment of the present disclosure;

FIG. 10 is an example illustration of luminance error patterns of groups of pixels at the electronic display of the electronic device of FIG. 1, in accordance with embodiments of the present disclosure;

FIG. 11 is an example illustration of a histogram representing a visual threshold of high spatial frequency components on the electronic display of the electronic device of FIG. 1, in accordance with embodiments of the present disclosure;

FIG. 12 is a block diagram of the pixel uniformity correction circuitry of the electronic device of FIG. 1 including a group index lookup table (LUT), a group pattern LUT, and a scaler LUT, in accordance with embodiments of the present disclosure.

FIG. 13 is a block diagram of a group pixel uniformity correction (GPUC) block of the pixel uniformity correction circuitry of the electronic device of FIG. 1, in accordance with embodiments of the present disclosure;

FIG. 14 is an example illustration of the group index LUT and the group pattern LUT used by the pixel uniformity correction circuitry to perform compensation, in accordance with embodiments of the present disclosure;

FIG. 15 is a flowchart of a process for populating the group index LUT and the group pattern LUTs, in accordance with an embodiment of the present disclosure; and

FIG. 16 is a block diagram of the pixel uniformity correction circuitry of the electronic device of FIG. 1 including a two-dimensional (2D) LUT and a scaler LUT.

### DETAILED DESCRIPTION OF SPECIFIC EMBODIMENTS

One or more specific embodiments will be described below. In an effort to provide a concise description of these embodiments, not all features of an actual implementation are described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

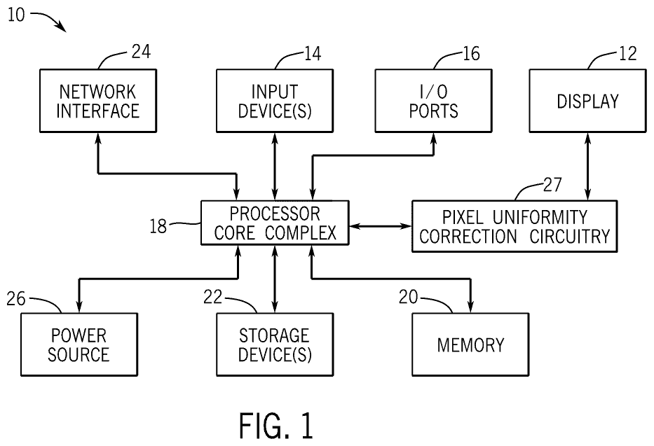

An example of an electronic device 10 having an electronic display 12 is shown in FIG. 1. As will be described in more detail below, the electronic device 10 may be any suitable electronic device, such as a computer, a mobile (e.g., portable) phone, a portable media device, a tablet device, a television, a handheld game platform, a personal data organizer, a virtual-reality headset, a mixed-reality headset, a vehicle dashboard, and/or the like. Thus, it should be noted that FIG. 1 is merely one example of a particular implementation and is intended to illustrate the types of components that may be present in an electronic device 10.

The electronic device 10 also includes one or more input devices 14, one or more input/output (I/O) ports 16, a processor core complex 18 having one or more processors or processor cores, main memory 20, one or more storage devices 22, a network interface 24, a power supply 26, and pixel uniformity correction circuitry 27. The various components described in FIG. 1 may include hardware elements (e.g., circuitry), software elements (e.g., a tangible, non-transitory computer-readable medium storing instructions), or a combination of both hardware and software elements. It should be noted that the various depicted components may be combined into fewer components or separated into additional components. For example, the main memory 20 and a storage device 22 may be included in a single component. Additionally or alternatively, the pixel uniformity correction circuitry 27 may be included in the processor core complex 18 or the electronic display 12. It should also be noted that the pixel uniformity correction circuitry 27 may be implemented in the central processing unit (CPU), the graphics processing unit (GPU), image signal processing pipeline, display pipeline, driving silicon, or any suitable processing device that is capable of processing image data in the digital domain before the image data is provided to the pixel circuitry.

The processor core complex 18 is operably coupled with main memory 20 and the storage device 22. As such, the processor core complex 18 may execute instructions stored in main memory 20 and/or a storage device 22 to perform operations, such as generating image data. Additionally or alternatively, the processor core complex 18 may operate based on circuit connections formed therein. As such, in some embodiments, the processor core complex 18 may include one or more general purpose microprocessors, one or more application specific processors (ASICs), one or more field programmable logic arrays (FPGAs), or any combination thereof.

The main memory 20 and/or the storage device 22 may store data, such as image data. Thus, in some embodiments, the main memory 20 and/or the storage device 22 may include one or more tangible, non-transitory, computer-readable media that store instructions executable by processing circuitry, such as the processor core complex 18 and/or the pixel uniformity correction circuitry 27, and/or data to be processed by the processing circuitry. For example, the main memory 20 may include random access memory (RAM) and the storage device 22 may include read only memory (ROM), rewritable non-volatile memory, such as flash memory, hard drives, optical discs, and/or the like.

The network interface 24 may enable the electronic device 10 to communicate with a communication network and/or another electronic device 10. For example, the network interface 24 may connect the electronic device 10 to a personal area network (PAN), such as a Bluetooth network, a local area network (LAN), such as an 802.11x Wi-Fi network, and/or a wide area network (WAN), such as a 4G or LTE cellular network or a 5G network. In other words, in some embodiments, the network interface 24 may enable the electronic device 10 to transmit data (e.g., image data) to a communication network and/or receive data from the communication network.

The power supply 26 may provide electrical power to operate the processor core complex 18 and/or other components in the electronic device 10. Thus, the power supply 26 may include any suitable source of electrical power, such as a rechargeable lithium polymer (Li-poly) battery and/or an alternating current (AC) power converter.

Furthermore, the processor core complex 18 is operably coupled with one or more I/O ports 16. The I/O ports 16 may enable the electronic device 10 to interface with another electronic device 10. For example, a portable storage device may be connected to an I/O port 16, thereby enabling the electronic device 10 to communicate data, such as image data, with the portable storage device.

The processor core complex 18 is also operably coupled with one or more input devices 14. An input device 14 may enable a user to interact with the electronic device 10. For example, the input devices 14 may include one or more buttons, one or more keyboards, one or more mice, one or more trackpads, and/or the like. Additionally, in some embodiments, the input devices 14 may include touch sensing components implemented in the electronic display 12. The touch sensing components may receive user inputs by detecting occurrence and/or position of an object contacting the display surface of the electronic display 12.

In addition to enabling user inputs, the electronic display 12 may facilitate providing visual representations of information by displaying one or more images (e.g., image frames or pictures). For example, the electronic display 12 may display a graphical user interface (GUI) of an operating system, an application interface, text, a still image, or video content. To facilitate displaying images, as will be described in more detail below, the electronic display 12 may include a display panel with one or more display pixels.

As described above, an electronic display 12 may display an image by controlling luminance of its display pixels based at least in part on image data associated with corresponding image pixels (e.g., points) in the image. The image data may be generated by an image source, such as the processor core complex 18, a graphics processing unit (GPU), and/or an image sensor. Additionally or alternatively, in some embodiments, image data may be received from another electronic device 10, for example, via the network interface 24 and/or an I/O port 16. In any case, as described above, the electronic device 10 may be any suitable electronic device.

The pixel uniformity correction circuitry 27 may compensate for the non-uniform luminance characteristics of display pixels by using one or more pixel luminance correction factors that are selected based on pixel group error patterns. The pixel group error patterns may correspond to locations of the pixels of the display 12. Moreover, the pixel group luminance error patterns may be associated with pixel groups of at least two-by-two (e.g., 2×2) pixels.

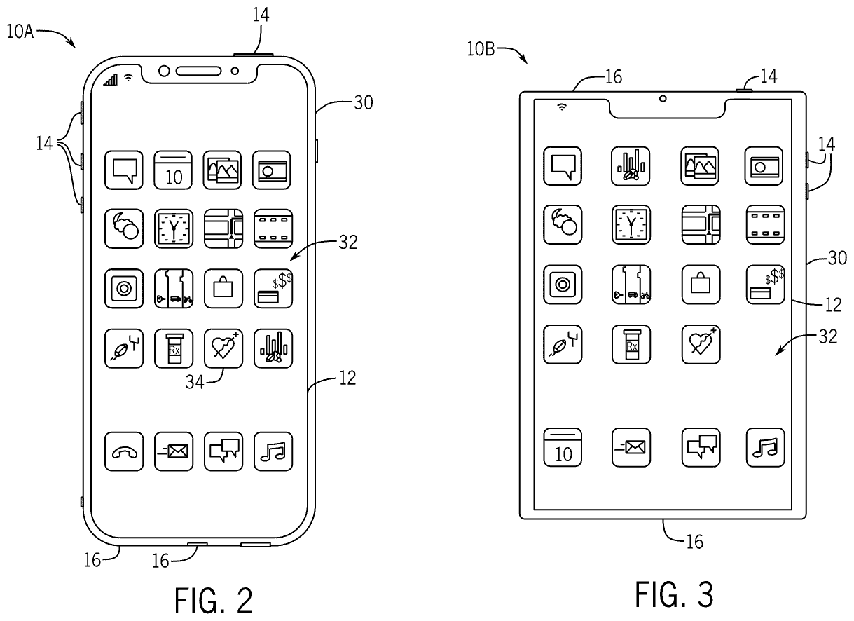

To help illustrate, one example of a suitable electronic device 10, specifically a handheld device 10A, is shown in FIG. 2. In some embodiments, the handheld device 10A may be a portable phone, a media player, a personal data organizer, a handheld game platform, and/or the like. For example, the handheld device 10A may be a smart phone, such as any iPhone® model available from Apple Inc.

The handheld device 10A includes an enclosure 28 (e.g., housing). The enclosure 28 may protect interior components from physical damage and/or shield them from electromagnetic interference. Additionally, the enclosure 28 surrounds the electronic display 12. The electronic display 12 is displaying a graphical user interface (GUI) 30 having an array of icons 32. By way of example, when an icon 32 is selected either by an input device 14 or a touch sensing component of the electronic display 12, an application program may launch.

Furthermore, input devices 14 open through the enclosure 28. As described above, the input devices 14 may enable a user to interact with the handheld device 10A. For example, the input devices 14 may enable the user to activate or deactivate the handheld device 10A, navigate a user interface to a home screen, navigate a user interface to a user-configurable application screen, activate a voice-recognition feature, provide volume control, and/or toggle between vibrate and ring modes. The I/O ports 16 also open through the enclosure 28. In some embodiments, the I/O ports 16 may include, for example, an audio jack to connect to external devices.

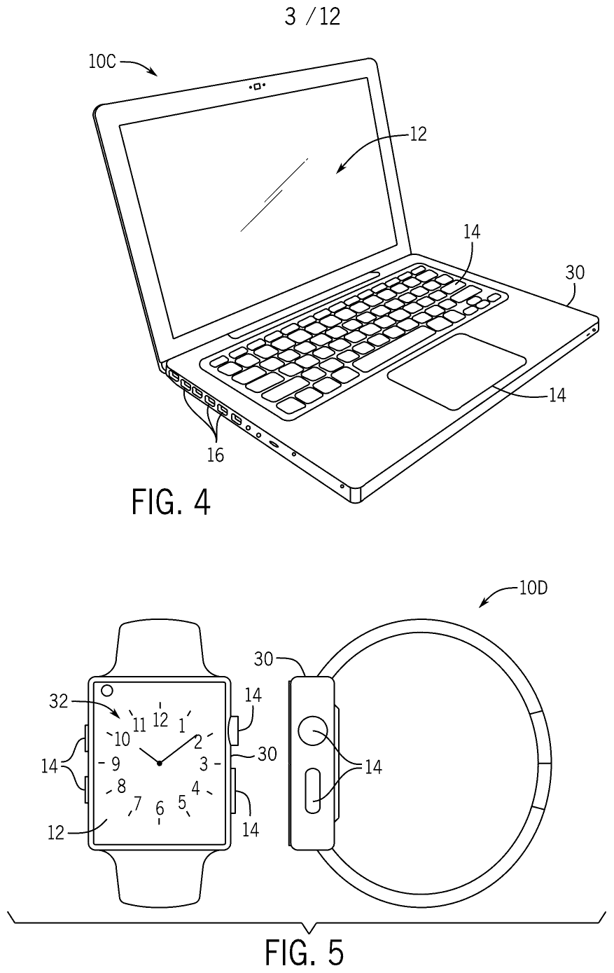

Another example of a suitable electronic device 10, specifically a tablet device 10B, is shown in FIG. 3. For illustrative purposes, the tablet device 10B may be any iPad® model available from Apple Inc. A further example of a suitable electronic device 10, specifically a computer 10C, is shown in FIG. 4. For illustrative purposes, the computer 10C may be any Macbook® or iMac® model available from Apple Inc. Another example of a suitable electronic device 10, specifically a watch 10D, is shown in FIG. 5. For illustrative purposes, the watch 10D may be any Apple Watch® model available from Apple Inc. The tablet device 10B, the computer 10C, and the watch 10D each also includes an electronic display 12, input devices 14, I/O ports 16, and an enclosure 28. In any case, as described above, an electronic display 12 may generally display images based at least in part on image data, for example, output from the processor core complex 18 and/or the pixel uniformity correction circuitry 27.

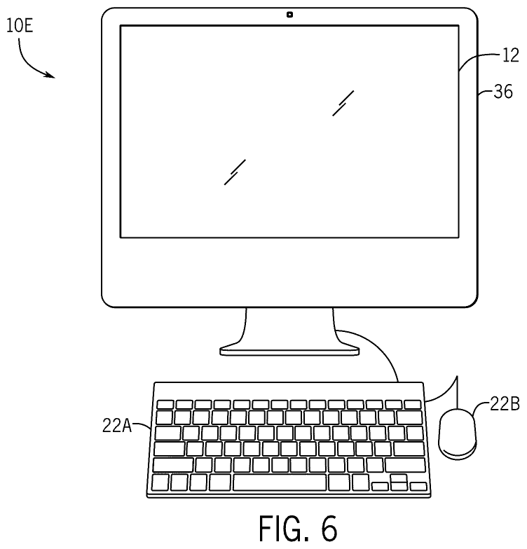

Turning to FIG. 6, a computer 10E may represent another embodiment of the electronic device 10 of FIG. 1. The computer 10E may be any computer, such as a desktop computer, a server, or a notebook computer, but may also be a standalone media player or video gaming machine. By way of example, the computer 10E may be an iMac®, a MacBook®, or other similar device by Apple Inc. of Cupertino, California. It should be noted that the computer 10E may also represent a personal computer (PC) by another manufacturer. A similar enclosure 36 may be provided to protect and enclose internal components of the computer 10E, such as the electronic display 12. In certain embodiments, a user of the computer 10E may interact with the computer 10E using various peripheral input structures 14, such as the keyboard 14A or mouse 14B (e.g., input structures 14), which may connect to the computer 10E.

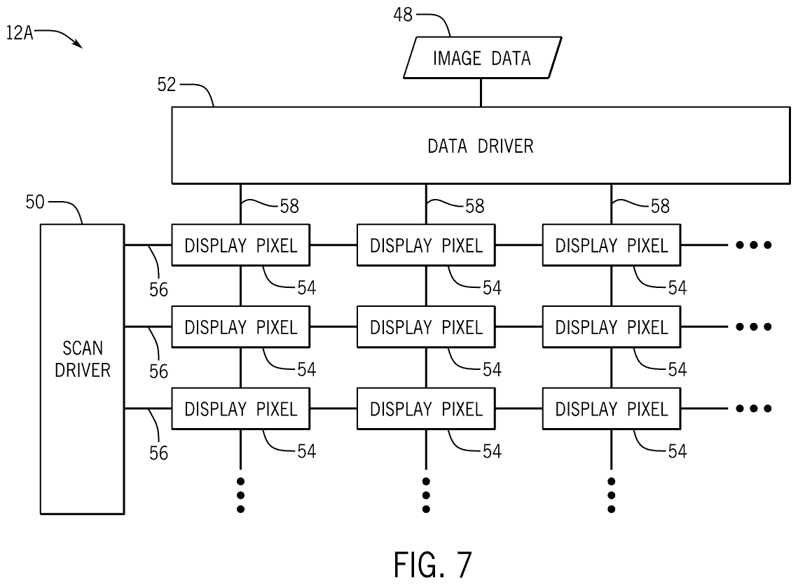

FIG. 7 illustrates one version of the electronic display 12 that may use pixel grouping to increase frame rates without consuming additional power and while preserving image quality. In FIG. 6, the electronic display 12 is shown as an electronic display 12A representing a liquid crystal display (LCD) or an organic light emitting diode (OLED) display. The electronic display 12A may receive image data 48 for display. The electronic display 12A uses display driver circuitry that includes scan driver circuitry 50 and data driver circuitry 52 to program the image data 48 onto display pixels 54.

The display pixels 54 may each represent a liquid crystal (LC) cell to filter certain colors of light in various brightness levels from a backlight (not shown) or may contain one or more self-emissive elements, such as a light-emitting diodes (LEDs) (e.g., organic light emitting diodes (OLEDs) or micro-LEDs (μLEDs)). The display pixels 54 may also represent pixels of digital mirror devices (DMD) or other suitable display devices that may use pixel grouping. In any event, different display pixels 54 may emit different colors (e.g., red, green, blue (RGB)). For example, some of the display pixels 54 may emit red light, some may emit green light, and some may emit blue light. Thus, the display pixels 54 may be driven to emit light at different brightness levels to cause a user viewing the electronic display 12A to perceive an image formed from different colors of light. The display pixels 54 may also correspond to hue and/or luminance levels of a color to be emitted and/or to alternative color combinations, such as combinations that use cyan, magenta, and yellow (CMY), or others.

The scan driver 50 may provide scan signals (e.g., pixel reset, data enable, on-bias stress) on scan lines 56 to control the display pixels 54 by row. For example, the scan driver 50 may cause one or more selected rows of the display pixels 54 to become enabled to receive a portion of the image data 48 from data lines 58 from the data driver 52. In this way, an image frame of image data 48 may be programmed onto the display pixels 54 row by row or selected groups of rows. As will be discussed in greater detail below, the pixel uniformity correction circuitry 27 may compensate for luminance properties (e.g., the non-uniform luminance characteristics) of the display pixels 54.

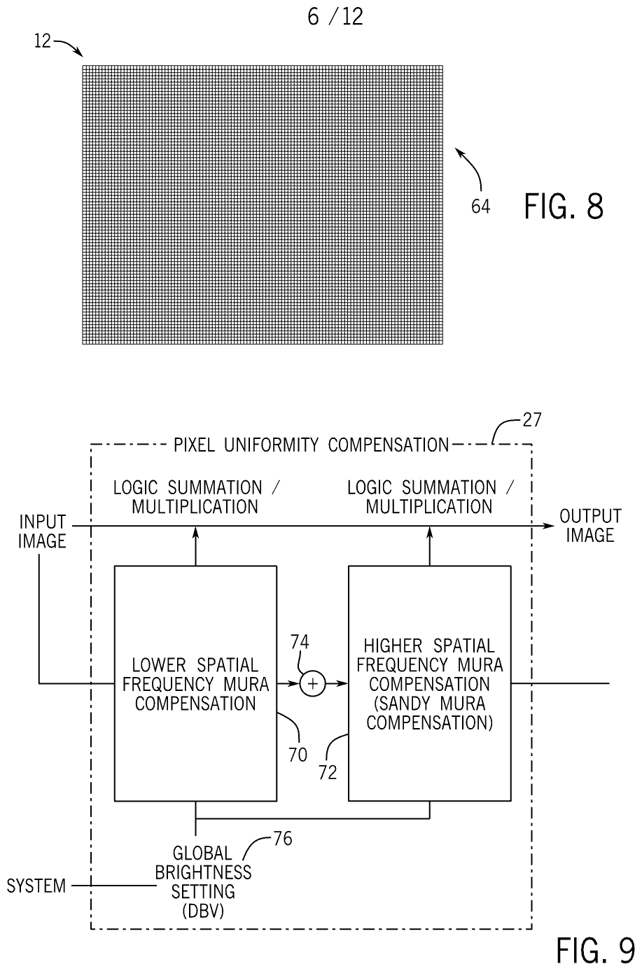

As an example, FIG. 8 is an illustration depicting image artifacts 64 (e.g., image defects) on the display 12 of the electronic device of FIG. 1, which may be caused by the non-uniform luminance characteristics. Indeed, without display pixel non-uniformity compensation, the image artifacts 64 may occur due to the non-uniform luminance characteristics. For example, as illustrated in FIG. 8, the image artifacts 64 may visually appear (e.g., be perceived) as repeating vertical and/or horizontal lines on the display 12.

The image artifacts 64 may include low-spatial-frequency components (e.g., lower spatial frequency mura) and high-spatial-frequency components (e.g., higher spatial frequency mura, sandy mura). The low-spatial-frequency components may depict coarse and/or rough features. The high spatial frequency components may depict details such as textures, edges, and/or patterns within an image. The low-spatial-frequency components and the high spatial frequency components may both contribute to human visual perception of the image presented on the display 12. However, after the pixel uniformity correction circuitry 27 compensates the low-spatial-frequency components and the high spatial frequency components, then the non-uniform luminance characteristics causing the image artifacts 64 may be visually reduced. For example, the image artifacts 64 may be invisible or partially invisible (e.g., not perceivable, less perceivable).

With the foregoing in mind, FIG. 9 is an illustration of a pixel uniformity correction data flow, in accordance with an embodiment of the present disclosure. As illustrated in FIG. 9, the pixel uniformity correction circuitry 27 may include lower spatial frequency mura compensation circuitry 70 and higher spatial frequency mura compensation circuitry 72 (e.g., Sandy mura compensation circuitry). The lower spatial frequency mura compensation circuitry 70 may compensate (e.g., correct) static non-uniform luminance characteristics of the display pixels 54, such as a gray level value (e.g., brightness, contrast, intensity of light). In an embodiment, the lower spatial frequency mura compensation circuitry 70 may compensate for binning of the display pixels 54. Moreover, the higher spatial frequency mura compensation circuitry 72 may correct for residual variations (e.g., local variation, differences, fluctuations) in the brightness, the contrast, and/or the intensity of light across a portion of or all of the display 12. Compensation determinations for the residual variations at the higher spatial frequency mura compensation circuitry 72 may be associated with eye sensitivity at low-level luminance and a high frequency noise occurring at the low-level luminance.

An input image may be input into the lower spatial frequency mura compensation circuitry 70. The lower spatial frequency mura compensation circuitry 70 may then generate correction data (e.g., compensation data, compensation matrix, a grid of values) for the static non-uniform luminance characteristics. Further, the lower spatial frequency mura compensation circuitry 70 may receive a global brightness setting (DBV) 76 from the electronic device 10.

At a summation block 74, the correction data may be added (e.g., summed) with correction data of the higher spatial frequency mura compensation circuitry 72 to determine a total correction data. The higher spatial frequency mura compensation circuitry 72 may enable determination of pixel luminance correction factors based on pixel group luminance error patterns, which may be summed with the correction data of the lower spatial frequency mura compensation circuitry 70.

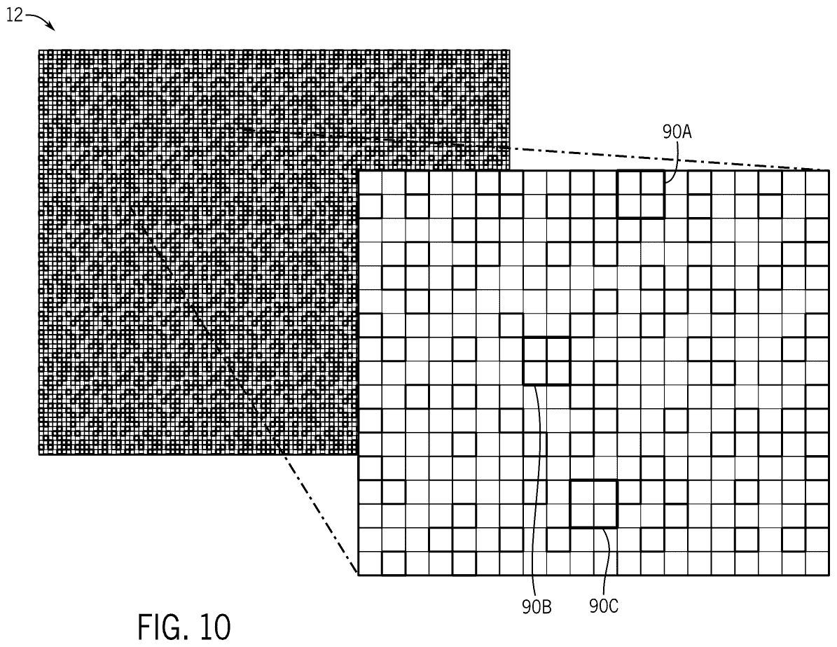

The pixel uniformity correction circuitry 27 may apply the total correction data to pixel data of the input image to reduce or eliminate the non-uniform luminance characteristics of the display pixels 54. In this manner, the lower spatial frequency mura compensation circuitry 70 and the higher spatial frequency mura compensation circuitry 72 may enable compensation and/or control of a voltage of each of the display pixels 54. Additional details regarding the higher spatial frequency mura compensation circuitry 72 will be described below with respect to FIGS. 10-15.

As described herein, the pixel uniformity correction circuitry 27 may compensate for the non-uniform luminance characteristics of the display pixels 54 based on a pixel luminance correction factor that is selected based on pixel group luminance error patterns corresponding to location of the display pixels 54. FIG. 10 is an example illustration of pixel group luminance error patterns 90 (e.g., 90A, 90B, 90C) of groups of pixels (e.g., groups of the display pixels 54) at the display 12 of the electronic device 10, in accordance with an embodiment of the present disclosure.

Instead of compensating for each individual pixel (e.g., 1×1), using a large amount of memory and power, the pixel uniformity correction circuitry 27 may record and store (e.g., in the memory 20) error patterns of groups (e.g., via the higher spatial frequency mura compensation circuitry 72). Indeed, the pixel uniformity correction circuitry 27 may identify pixel groups with patterns of luminance behavior within threshold similarity. Additionally, a group index LUT may be populated based on prevalence of the pixel group luminance error patterns 90, and a group pattern LUT may be populated based on locations of the pixel group luminance error patterns 90 on the display 12.

For example, as illustrated in FIG. 10, the pixel group luminance error patterns 90 may be associated with the pixel group luminance error patterns 90 of groups of two display pixels by two display pixels (e.g., 2×2 binning). It should be noted that although groups of two display pixels by two display pixels are shown, any suitable number of pixels greater than two pixels may be included in the groups. As an example, the pixel group luminance error patterns 90 may be associated with groups of four display pixels by four display pixels, eight display pixels by eight display pixels, and so on.

The pixel group luminance error patterns 90 may be grouped (e.g., binned) according to similarities between each of the display pixels 54. For example, the pixel group luminance error patterns may be grouped based on a delta luminance between each of the display pixels 54. The delta luminance may refer to a difference in brightness between two points (e.g., pixels) or areas (e.g., groups of pixels) on the display 12. For example, the delta luminance may measure a variation in luminance or a brightness level between the two points. When the delta luminance between pixel to pixel is within a contrast sensitivity threshold, the non-uniform luminance characteristics may not be perceivable by a human eye. The contrast sensitivity threshold may include any suitable range of the delta luminance (e.g., between 5% and −5%, 10% and −10%, 15% and −15%, 20% and −20%, or the like).

When the luminance delta of the pixel group luminance error patterns 90 are within the contrast sensitivity threshold, at a close examination (e.g., a zoomed in view), the variations or differences of pixels within the pixel group luminance error patterns 90 may be perceivable (e.g., apparent) by the human eye. However, at a normal distance (e.g., not zoomed in), the variations or differences of pixels within the pixel group luminance error patterns 90 may not be perceivable or noticeable by the human eye.

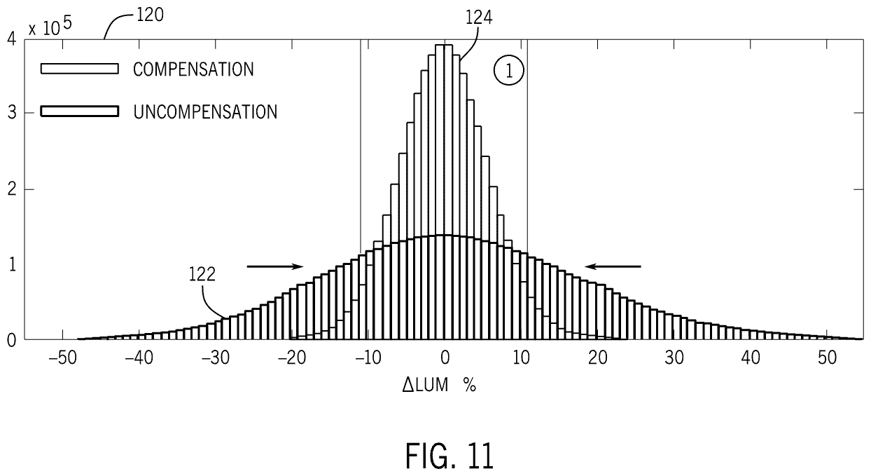

As an example, FIG. 11 is an example illustration of a histogram 120 representing a visual threshold of high spatial frequency components, in accordance with an embodiment of the present disclosure. In particular, the histogram 120 illustrates a luminance delta distribution based on the display pixels 54 of the electronic display 12. As shown in FIG. 11, an uncompensated distribution 122 may include points along the luminance delta distribution with a larger dispersion (e.g., a broader spread). The larger dispersion may occur due to increases in variance of the delta luminance. As described herein, the delta luminance outside the contrast sensitivity threshold (e.g., within −10% and 10% of the delta luminance) may be perceivable to the human eye. Thus, the uncompensated distribution 122 may be associated with the display 12 of the electronic device 10 including a higher amount of the high spatial frequency components (e.g., image artifacts).

Further, as shown in FIG. 11, a compensated distribution 124 (e.g., by the pixel uniformity correction circuitry 27) may include points along the luminance with a narrow dispersion (e.g., a smaller spread). The narrow dispersion may occur due to decreases in the variance of the delta luminance. The delta luminance within the contrast sensitivity threshold may not be perceivable to the human eye. Thus, the compensated distribution 124 may be associated with the display 12 of the electronic device 10 including a lower amount (e.g., none or almost none) of the high spatial frequency components.

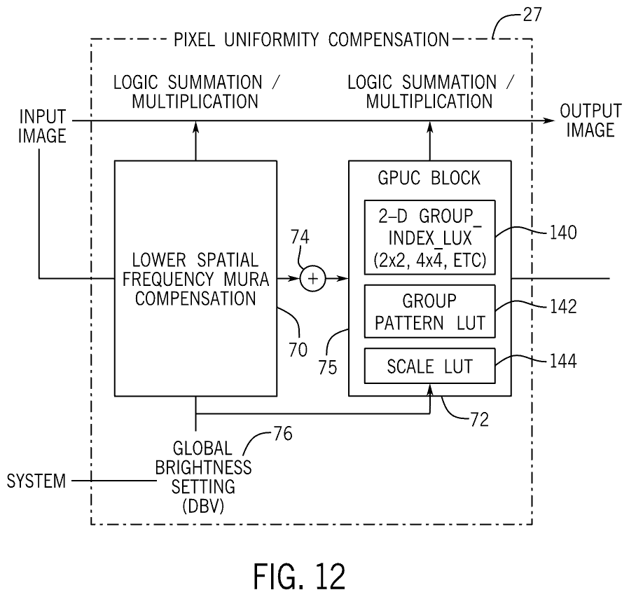

As described herein, the pixel uniformity correction circuitry 27 may include the lower spatial frequency mura compensation circuitry 70 and the higher spatial frequency mura compensation circuitry 72. FIG. 12 is a block diagram of the pixel uniformity correction circuitry 27 of the electronic device 10 of FIG. 1 including the lower spatial frequency mura compensation circuitry 70 and a group pixel uniformity correction (GPUC) block 75 (e.g., image processing circuitry). The GPUC block 75 may include a group index LUT 140, a group pattern LUT 142, and a scaler LUT 144. The group index LUT 140 may define pixel luminance correction factors based on the pixel group luminance error patterns 90. For example, the group index LUT 140 may define at least four of the pixel luminance correction factors per each of the pixel group luminance error patterns 90.

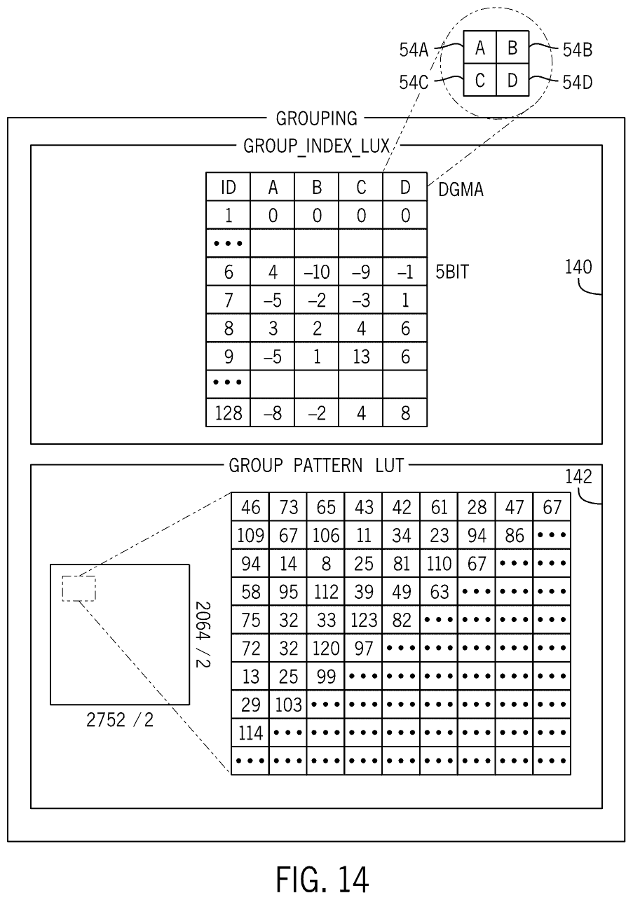

The group index LUT 140 may also store the pixel luminance correction factor for a number of pixel group luminance error patterns 90 (e.g., 128-pixel groups). The group pattern LUT 142 may define locations of the pixel group luminance error patterns on the display 12. Further, the scaler LUT 144 may define a scaling factor for the pixel luminance correction factors based on the global brightness setting 76 of the display 12. The correction data produced by the lower spatial frequency mura compensation circuitry 70 may be added with correction data of the GPUC block 75 at the summation block 74 to determine the total correction data. Additional detail with respect to the group index LUT 140 and the group pattern LUT 142 will be described below with respect to FIG. 14.

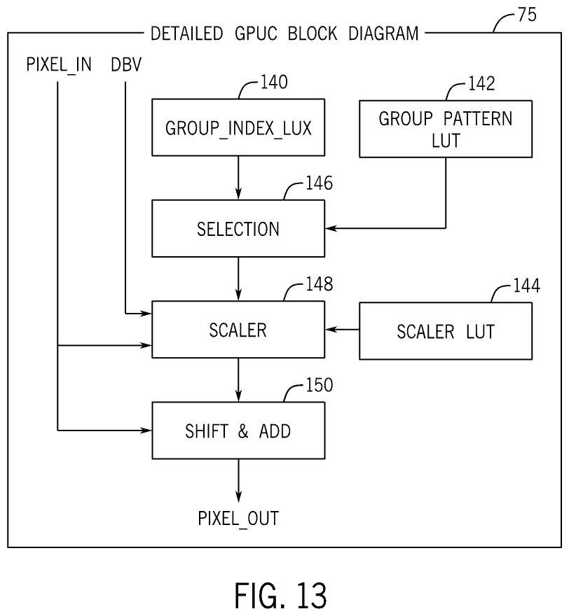

FIG. 13 is a block diagram of the GPUC block 75 of the pixel uniformity correction circuitry 27 of the electronic device 10 of FIG. 1, in accordance with embodiments of the present disclosure. As described herein, the GPUC block 75 may include the group index LUT 140, the group pattern LUT 142, and/or the scaler LUT 144. Moreover, the GPUC block 75 may include selection circuitry 146, scaler circuitry 148, and/or shift and/or add circuitry 150.

The selection circuitry 146 may obtain the pixel luminance correction factor for pixel data of a particular display pixel 54 of the display 12. For example, the selection circuitry 146 may obtain the pixel luminance correction factor from the group index LUT 140 and the group pattern LUT 142. Thus, compensation of the pixel data for the non-uniform luminance characteristics of the display pixels 54 of the display 12 may be at least partially performed via the selection circuitry 146.

The scaler circuitry 148 may enable application of a scaling factor to the pixel luminance correction factor that is obtained by the selection circuitry 146. As an example, the scaling factor may be based on the global brightness setting 76 of the display 12. The scaling factor may be provided to the scaler circuitry 148 by the scaler LUT 144. Indeed, the scaler LUT 144 may define the scaling factor for the pixel luminance correction factors based on the global brightness setting 76 of the display 12. Additionally or alternatively, the GPUC block 75 may include the shift or add, or both shift and add circuitry 150, which may enable an adjustment of the pixel data for the particular display pixel 54 of the display 12 based on the luminance correction factor.

FIG. 14 is an example illustration of the group index LUT 140 and the group pattern LUT 142 used by the pixel uniformity correction circuitry to perform compensation, in accordance with embodiments of the present disclosure. As an example, as illustrated in FIG. 14, there may be 128 groups of two display pixels by two display pixels (e.g., of the display pixels 54). Although 128 groups are described as being stored within the group index LUT 140, any suitable number of groups may be stored. Within the group index LUT 140, a first display pixel 54A may be associated with ‘A,’ a second display pixel 54B may be associated with ‘B,’ a third display pixel 54C may be associated with ‘C,’ and a fourth display pixel may be associated with ‘D.’ Each number and/or letter stored within the group index LUT 140 (e.g., A-D and/or 1-128) may be associated with the same number and/or the same letter stored within the group pattern LUT 142. In this manner, the group index LUT 140 may define at least four of the pixel luminance correction factors per pixel group luminance error pattern.

As such, the group index LUT 140 may enable defining of the pixel luminance correction factors based on pixel group luminance error patterns. The pixel luminance correction factors may then be used to compensate for the non-uniform luminance characteristics of the display pixels 54 of the display 12. Further, the group pattern LUT 142 may define the locations of the pixel group luminance error patterns 90 on the display 12. The per-pixel-group set of correction factors may be applied to the pixel data that is sent to the display pixels 54, which results in a reduction or an elimination of the non-uniform luminance characteristics of the display pixels 54 within a threshold (e.g., the contrast sensitivity threshold) of the human visual acuity.

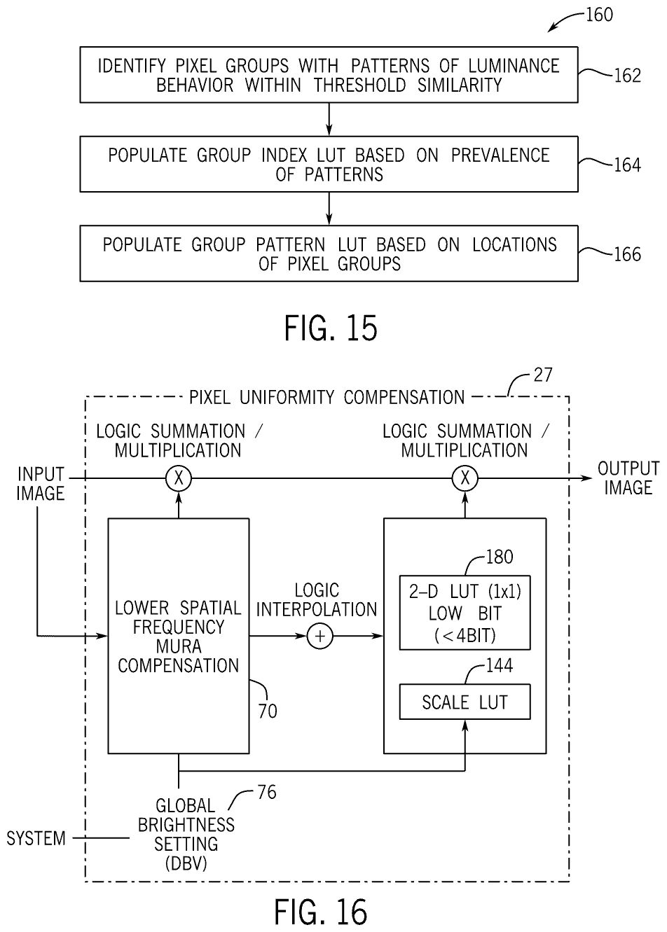

FIG. 15 is a flowchart of a process 160 for populating the group index LUT and the group pattern LUTs, in accordance with embodiments of the present disclosure. Any suitable device (e.g., a controller) that may control components of the electronic device 10, such as the processor 18, may perform the process 160. In some embodiments, the process 160 may be implemented by executing instructions stored in a tangible, non-transitory, computer-readable medium, such as the memory 20 or the storage 22, using the processor 18. For example, the process 160 may be performed at least in part by one or more software components, such as an operating system of the electronic device 10, one or more software applications of the electronic device 10, and the like. While the process 160 is described using steps in a specific sequence, it should be understood that the present disclosure contemplates that the described steps may be performed in different sequences than the sequence illustrated, and certain described steps may be skipped or not performed altogether.

As described herein, at process block 162, the processor 18 may identify pixel groups with patterns of luminance behavior (e.g., the luminance delta) within a threshold similarity (e.g., the contrast sensitivity threshold). For example, the threshold similarity may include the range of the delta luminance between ten percent and negative ten percent. As another example, the processor 18 may perform image analysis or implement algorithms to efficiently identify and analyze the pixel groups with the patterns of luminance behavior within the threshold similarity (e.g., identify the pixel groups with the most similar or closest patterns).

The image analysis or implementation of the algorithms may enable improved accuracy and efficiency in detecting the pixel groups within the threshold similarity. In some embodiments, the image analysis or the algorithms may include performance of root mean square (RMS) of an image, which is a statistical measure that may quantify the intensity or brightness variations present in the pixel groups. The RMS of the image is calculated by taking a square root of an average of the pixel groups (e.g., squares) in the image.

At process block 164, the processor 18 may populate the group index LUT 140 based on the prevalence of patterns. The processor 18 may populate the group index LUT 140 with the pixel luminance correction factors based on the identified pixel groups with the patterns of the luminance behavior within the threshold similarity. For example, the group index LUT 140 may be populated with pixel luminance correction factors for at least or for at most 128-pixel group luminance error patterns. Therefore, the population of the group index LUT 140 may define the pixel luminance correction factors per pixel group luminance error pattern.

At process block 166, the processor 18 may populate the group pattern LUT 142 based on locations of the pixel groups. For example, as illustrated in FIG. 14, each pixel group may be associated with an identification (ID). Thus, the group pattern LUT 142 may be populated to include the ID of each of the pixel groups to define the locations of the pixel group luminance error patterns on the display 12. In this manner, the processor 18 may use the group index LUT 140 and the group pattern LUT 142 to determine the pixel group luminance error patterns corresponding to locations of the display 12, the pixel luminance correction factors corresponding to the pixel group luminance error patterns, and adjust the pixel data corresponding to the location of the display pixels 54 based on the pixel luminance correction factors.

In some embodiments, it may be useful for the pixel uniformity correction circuitry to compensate for the non-uniform luminance characteristics of the display pixels 54 on a per-pixel basis based on a per-pixel correction factor applied to the pixel data. However, to reduce the use of memory used in the per-pixel basis compensation, a LUT with a lower bit depth may be implemented to compensate and control the voltage of each of the display pixels 54.

With the foregoing in mind, FIG. 16 is a block diagram of the pixel uniformity correction circuitry 27 of the electronic device 10 of FIG. 1 including the lower spatial frequency mura compensation circuitry 70, a two-dimensional (2D) LUT 180, and the scaler LUT 144. The 2D LUT 180 may include a low bit depth, for example, less than four bits per pixel (e.g., three bits or less). The 2D LUT 180 scaler factors may be controlled by the global brightness setting 76 (e.g., the brightness and gray level) used in the electronic device 10.

The pixel uniformity correction circuitry 27 may quantize the compensation value (e.g., a mura, a voltage, a luminance value) to a number of stages (e.g., a number of levels). For example, the pixel uniformity correction circuitry 27 may quantize the mura from one through sixteen stages, which are each four-bit stages, rather than using a high bit depth and fine steps. The quantized compensation value may be determined (e.g., obtained) by identifying compensation of each individual pixel of the display pixels 54 between the display 12 (e.g., the front of screen), with and/or without high frequency compensation blocks. Thus, the quantized compensation value may be used to compensate a range of the voltage and/or luminance of the display 12.

Accordingly, the techniques described herein for compensating for the non-uniform luminance characteristics of the display pixels 54 may enable a visual improvement of uniformity and smoothness of the display 12 of the electronic device while decreasing the amount of the memory 20 used for compensation. In this manner, the visual quality of the display 12 may be improved when viewed by the user.

The specific embodiments described above have been shown by way of example, and it should be understood that these embodiments may be susceptible to various modifications and alternative forms. It should be further understood that the claims are not intended to be limited to the particular forms disclosed, but rather to cover all modifications, equivalents, and alternatives falling within the spirit and scope of this disclosure.

The techniques presented and claimed herein are referenced and applied to material objects and concrete examples of a practical nature that demonstrably improve the present technical field and, as such, are not abstract, intangible, or purely theoretical. Further, if any claims appended to the end of this specification contain one or more elements designated as “means for [perform]ing [a function] . . . ” or “step for [perform]ing [a function] . . . ,” it is intended that such elements are to be interpreted under 35 U.S.C. 112(f). However, for any claims containing elements designated in any other manner, it is intended that such elements are not to be interpreted under 35 U.S.C. 112(f).

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

1. An electronic display comprising:
a display panel comprising a plurality of display pixels having non-uniform luminance characteristics; and
pixel uniformity correction circuitry configured to compensate for the non-uniform luminance characteristics of the display pixels based on pixel luminance correction factors selected based on pixel group luminance error patterns corresponding to locations of the display pixels.

2. The electronic display of claim 1, wherein the pixel group luminance error patterns describe luminance error patterns of groups of at least two display pixels by at least two display pixels.

3. The electronic display of claim 2, wherein the pixel group luminance error patterns describe luminance error patterns of groups of greater than two display pixels by greater than two display pixels.

4. The electronic display of claim 1, wherein the pixel uniformity correction circuitry comprises:
lower spatial frequency mura compensation circuitry configured to correct for static non-uniform luminance characteristics of the plurality of display pixels;
higher spatial frequency mura compensation circuitry configured to correct for local variations in the non-uniform luminance characteristics of the plurality of display pixels.

5. The electronic display of claim 1, wherein the pixel uniformity correction circuitry is configured to compensate for the non-uniform luminance characteristics of the plurality of display pixels using a per-pixel-group set of correction factors that, when applied to pixel data to be sent to the plurality of display pixels, reduces or eliminates non-uniform luminance characteristics of the plurality of display pixels within a threshold of human visual acuity.

6. The electronic display of claim 1, wherein the pixel uniformity correction circuitry comprises:
a group index lookup table (LUT) configured to define the pixel luminance correction factors based on the pixel group luminance error patterns; and
a group pattern LUT configured to define locations of the pixel group luminance error patterns on the display panel.

7. The electronic display of claim 6, comprising a scaler LUT configured to define a scaling factor for the pixel luminance correction factors based on a global brightness setting of the electronic display.

8. The electronic display of claim 6, wherein the group index LUT is configured to store the pixel luminance correction factors for at least 128-pixel group luminance error patterns.

9. The electronic display of claim 6, wherein the group index LUT is configured to store the pixel luminance correction factors for at most 128-pixel group luminance error patterns.

10. The electronic display of claim 6, wherein the group index LUT defines at least four of the pixel luminance correction factors per pixel group luminance error pattern.

11. Image processing circuitry comprising:
a group index lookup table (LUT) configured to define pixel luminance correction factors based on pixel group luminance error patterns, wherein the pixel luminance correction factors are configured to compensate for non-uniform luminance characteristics of display pixels of an electronic display;
a group pattern LUT configured to define locations of the pixel group luminance error patterns on the electronic display; and
selection circuitry configured to obtain the pixel luminance correction factor for pixel data for a particular display pixel of the electronic display from the group index LUT and the group pattern LUT to enable the pixel data to be compensated for the non-uniform luminance characteristics of the display pixels of the electronic display.

12. The image processing circuitry of claim 11, comprising:
scaler circuitry configured to apply a scaling factor to the pixel luminance correction factors obtained by the selection circuitry, wherein the scaling factor is based on a global brightness setting of the electronic display.

13. The image processing circuitry of claim 12, comprising:
a scaler LUT configured to define the scaling factor for the pixel luminance correction factors based on the global brightness setting of the electronic display.

14. The image processing circuitry of claim 11, comprising shift or add, or both shift and add circuitry configured to adjust the pixel data for the particular display pixel of the electronic display based on the pixel luminance correction factor.

15. The image processing circuitry of claim 11, wherein the pixel group luminance error patterns describe luminance error patterns of groups of at least two display pixels by at least two display pixels.

16. The image processing circuitry of claim 11, wherein the pixel group luminance error patterns describe luminance error patterns of groups of more than two display pixels by more than two display pixels.

17. A method comprising:
determine a pixel group luminance error pattern corresponding to a location of a display pixel on an electronic display;
determine pixel luminance correction factors corresponding to the pixel group luminance error pattern; and
adjust pixel data corresponding to the location of the display pixel based on the pixel luminance correction factors.

18. The method of claim 17, wherein the pixel group luminance error pattern is determined based on a group pattern lookup table (LUT) that defines locations of pixel group luminance error pattern on the electronic display.

19. The method of claim 17, wherein the pixel luminance correction factors are determined based on a group index lookup table (LUT) that defines the pixel luminance correction factors based on the pixel group luminance error pattern.

20. An electronic device comprising:
processing circuitry configured to generate pixel data; and
an electronic display comprising:
a display panel comprising a plurality of display pixels having non-uniform luminance characteristics; and
pixel uniformity correction circuitry configured to compensate for the non-uniform luminance characteristics of the display pixels on a per-pixel basis based on a per-pixel correction factor applied to the pixel data, wherein the per-pixel correction factor has a bit depth of 3 bits or lower.

21. The electronic device of claim 20, wherein the per-pixel correction factor has a bit depth of 2 bits or lower.
